(19) United States
(12) Patent Application Publication
(10) Pub. No.: US 2006/0055786 A1
(43) Pub. Date: Mar. 16, 2006

(54) Portable camera and wiring harness

(75) Inventor: David J. Ollila, Marquette, MI (US)

Correspondence Address: DOBRUSIN & THENNISCH PC, 29 W LAWRENCE ST, SUITE 210, PONTIAC, MI, 48342, US

(73) Assignee: Viosport

(21) Appl. No.: 11/239,896

(22) Filed: Sep. 30, 2005

Related U.S. Application Data
(63) Continuation-in-part of application No. 10/796,356, filed on Mar. 9, 2004.

(51) Int. Cl. H04N 5/225

(52) U.S. Cl. 348/207.99

(57) ABSTRACT

A communication system and device, such as wiring harness for a portable point-of-view camera includes a power cord, a recording cord and a camera cord and other devices to facilitate receipt, transference, or recordation of communication signals and information. The three cords may be mutually interconnected and can be respectively joined with a power source, a recording device, and a camera. A microphone or other devices may be integrated into or associated with the wiring harness or the camera. The technology may be directed to, for example, activities such as law enforcement operations; military operations; and counter-terrorism measures and operations.

### RELATED APPLICATION

This application is a continuation-in-part of, and claims priority to, the U.S. patent application Ser. No. 10/796,356, entitled “Portable Camera and Wiring Harness”, filed on Mar. 9, 2004, which application is hereby incorporated by reference in its entirety.

### BACKGROUND

Advances in recording technology and a growing interest in video and audio capture for a variety of applications has created a growing market for point-of-view cameras, which can be clipped to a user's helmet or other clothing item or to equipment. The point-of-view camera can then be used to record images that approximately match the user's perspective when engaged in an activity.

Current state-of-the-art technology re-purposes small (approximately 1″×3″) security cameras for use as portable point-of-view cameras. Such a camera is illustrated in FIG. 1 and includes the following major components: a camera including a lens 12, a lens cover 14, a charge-coupled device (CCD) 16, a signal processor 18, a printed circuit board (PCB) 20, and a casing 22; the camera is connected to a cable 24 to which a video terminal 26 and power terminal 28 are coupled.

The current state-of-the-art, point-of-view camera (e.g., “helmet cam”) is coupled with the recording device (e.g., a camcorder) and other recording equipment, as illustrated in FIG. 2, via the following eight detachable connections:
1) Connector pair 31 couples the power supply 40 with a power splitter 42.
2) Connector pair 32 couples a camera 44 with the power splitter 42.
3) Connector pair 33 couples a microphone 46 with the power splitter 42.
4) Connector pair 34 includes a video connector 48 of an audio/video cable 50 coupled with the RCA terminal of a BNC-to-RCA adapter 52.
5) Connector pair 35 includes a connector on the camera's video output cable 54 coupled with the BNC terminal of the BNC-to-RCA adapter 52.
6) Connector pair 36 includes a connector extended from the microphone 46 coupled with an audio connector 56 of the audio/video cable 50.
7) Connector pair 37 couples the audio/video cable 50 with a camcorder 58.
8) Finally, connector pair 38 couples the camcorder 58 with a remote control 60.

The BNC-to-RCA adapter 52 is required because the security cameras that were utilized as point-of-view cameras included BNC output connectors.

Since the advent of the current technology, new applications for capturing, receiving, and transferring various types of communication and information have come about. For example, in the law enforcement and security arenas, security-related surveillance and observation operations have taken on paramount importance in the current climate. Strategies are needed to expose, prevent, deter, or thwart hostile activities and groups. Such hostile activities may include, for example, criminal activities, terrorist cells and acts, and other activities designed to, or capable of, causing injury, death, damage, and destruction to persons and property. Effective strategies and successful operations, therefore, are critical to the safety and well-being of individuals, groups, and entire populations.

Typically, counter-terrorism measures include some type of information gathering, recording, and transfer functions. For example, video surveillance may be initiated to observe and/or record the actions and locations of suspicious persons and activities for action by law enforcement or military personnel as well as preserving and documenting potential evidence.

Information-related operations, however, carry risks. Some risks may include risk of detection of the individual or teams surveying the situation; risk of detection of the surveillance equipment; or risk of failure of the mission. Such failure may be due to an inability to effectively communicate; due to adverse environmental or situational conditions; or due to equipment nonconformance. Of significance, detection and mission failure may result in adverse consequences for the detected personnel; for the counterterrorist groups; and for the groups sought to be protected from terrorists' acts or other hostile acts.

For example, military operations directed to capturing images of enemy maneuvers, positions, or locations, such as reconnaissance or combat missions, may require the military personnel to advance into dangerous territory or areas that need to be recorded, mapped, or documented for future reference and/or intelligence purposes. Military personnel may have to expose themselves in certain areas, such as around the corner of a building or other obstacle to ascertain the location of the enemy or other party under surveillance. On doing so, the personnel may place themselves directly in the line of hostile or friendly fire and may need instant communication for assistance, support, etc. Personnel may also inadvertently subject themselves to detection by the enemy if their equipment is detectable. For example, despite the soldier's attempt to blend in with the surrounding landscape, the surveillance equipment may reflect the sun's rays, visually broadcasting its location to the enemy. Soldiers may also find themselves at the mercy of their environment, which may not accommodate the mission at hand. For example, efforts to capture video information by camera may be hampered by inclement weather conditions.

Another example of application relates to undercover surveillance situations such as personal interviews or evidence gathering purposes in which the interview must be covertly captured. Cameras, microphones, and cables must function to capture, for example, the audio and video aspects of the interview, yet the equipment must remain undetectable during such operations.

Yet another example of application relates to dynamically capturing, receiving, and transferring various types of communication, information, images, or footage of events as they occur or transpire to be recorded, archived, transferred, disseminated, or reviewed by others for specific images, events, or time-sequenced occurrences within the recorded material or scenes, which may consist of video, visual, audio or digital information. The present invention provides a wearable or rugged capture system that allows for hands-free, hassle-free, automatic and/or continuous capturing of video, audio, and global positioning satellite (GPS) coordinate capture or location data which will be recorded into packages of digital information that can be stored for later retrieval or disseminated/transmitted to others in real time or after recordation. The present invention allows a user or a remote viewer to view, review, and capture events through an unobtrusive and hands-free high quality digital audio, video and meta-data in rugged or difficult environments. For example, a surveillance team may have to simultaneously capture information relating to persons carrying on a variety of activities over given period of time. The surveillance personnel may require receipt of instructions from commanding officers at remote locations to proceed. The direction the surveillance takes may depend on the received instructions, the number of persons surveyed, the activities in which the persons are engaged, or the manner in which events unfold. Such direction may require configuring and reconfiguring various components quickly and efficiently to meet the changing conditions of the situation. Moreover, this process can be expedited utilizing the present invention and its features relating to immediate scene or event flagging on the recording device or after action recording which may be instantly viewed and/or reviewed.

It is contemplated that the components or modules of the wearable or rugged capture system of the present invention would include: (i) at least one flash-based digital recording device, (ii) at least one remote video camera capable of receiving and capturing video images, audio content, light, heat, or other spectral energy having digital signaling and digital zoom capability, including a plurality of interchangeable lenses, supporting fields of view from at least 24.5 to 92.5 degrees, and neutral density filters which provide a variety of views in varying light conditions and may be directed to particular uses, such as night vision enhancement, (iii) a remote control means or apparatus, and (iv) a universal camera mount. In a preferred embodiment, the user will mount the camera on or to a helmet or other piece of headgear or body covering worn or affixed to a portion of the human body or other fixed or mobile location. The recordation of images, events, or time-sequenced occurrences (i.e. scene recording) can be continuous, real-time, or post-event and may be started, stopped, or paused using a remote control means or apparatus. Scenes, images, or recorded material can be played back for immediate review in the field using a digital recording device well known in the art to ensure that the image was recorded or for verification purposes, and unwanted scene recording(s) can be deleted. The scene recordings(s) or data may be stored on removable flash media cards which can be loaded directly into a drive bay on a personal computer or data or content may be uploaded through an integrated USB OTG port associated with the components of the system. A particularly preferred feature or embodiment relates to the flash-based media or digital recording device which allows specific time-sequences, images, or events to be loaded and uploaded from flash media cards and/or flagged for expedited review to ensure that a particular event was captured and recorded or to process the information in the flagged scene for an immediate decision or next event by the user. Complete events or flagged scenes, images, or events can be viewed, reviewed, and processed by either the user or others in an expedited manner. For example, if a user is desirous to view or review a certain discrete event the flash media cards or flagged scenes recorded and provided by the present invention can be available for immediate review and assessment thereby alleviating the user or viewer to review or play unwanted scenes or images and increase response and/or reaction time, especially for security and/or law enforcement applications.

As can be seen, safe and effective surveillance requires, at a minimum, (1) equipment well-suited to the application, to the environment, and to the task at hand; (2) unobtrusive surveillance equipment; (3) easily portable, highly configurable, and highly interconnective equipment, including versatile connectivity to and from other components and peripherals that may be necessary for the mission at hand.

### SUMMARY

A wiring harness is herein described that can connect a camera, a power source and a recording device to enable transmission of power and electronic data signals therebetween with far fewer connections than have been employed in previous wiring configurations. The wiring harness includes a power cord having a connector that can be connected with the power supply, a recording cord having a connector that can be connected with a recording device, and a camera cord having a connector that can be connected with a camera. The camera cord is also coupled with the power cord so as to enable the camera to receive power from the power supply and with the recording cord so that the camera can transmit visual data from the camera to the recording device. Further still, a microphone can be integrated into the camera cord so that it can transmit audio signals to the recording device.

The camera can be mounted on a user's helmet, bicycle, weapon or other article of clothing or equipment (or directly to the user), and the user can then engage in an activity (e.g., sport, observation, demonstration, surveillance, combat, or broadcast entertainment/performance) and have the camera record an audio and video stream that closely matches the user's experience and observations. Alternatively, the camera can be mounted to another animate or inanimate host (other than the user) to record from an alternative perspective.

Advantages offered by embodiments of the apparatus and methods of this disclosure (referred to herein as the “new design”) over the current state-of-the-art apparatus, described above, include the following. The new design is better optimized for point-of-view camera applications and other uses. The reduced number of connections in the new design make the apparatus less confusing and cumbersome. The reduced number of connections, particularly between the recording device and the microphone and camera, also improves the integrity of signals transmitted to the recording device. A point-of-view camera utilizing the new design allows easy disconnection of the harness from the camera. Reduction in the number of separate components in the apparatus simplifies the system and reduces overall system weight and bulk. Fewer cables and reduced cable lengths in the new design can reduce the cable management problems that plagued the state-of-the-art apparatus. Multiple cable lengths can readily be provided via complementary use of an extension cord coupled with the camera. Finally, connection (i.e., plug-type) converters are no longer necessary to enable coupling and communication between components joined by the wiring harness.

In various aspects of the technology, various communication systems and devices having, for example, components, subcomponents, peripheral devices, or combinations thereof, may be directed to various applications, including, for example, communication of information or data. These applications may include, but are not limited to, information gathering, capturing, storage, receipt, and transfer, such as that related to counter-terrorism, law enforcement, military, and surveillance activities. For example, the technology may facilitate “remote viewing” of an object or area; i.e., the ability for an individual to view a designated object or area without the individual being viewable by others in the designated area. In yet another example, the technology may facilitate transmission or receipt of an audio signal, video signal, or audio-video signal to or from a remote device via, for example, wired or wireless communication media.

### BRIEF DESCRIPTION OF THE DRAWINGS

In the accompanying drawings, described below, like reference characters refer to the same or similar parts throughout the different views. The drawings are not necessarily to scale, emphasis instead being placed upon illustrating particular principles of the methods and apparatus characterized in the Detailed Description.

FIG. 1 is a disassembled view of an existing camera.

FIG. 2 is an image of an existing audio-video recording apparatus.

FIG. 3 is an image of an audio-video recording apparatus of this disclosure.

FIG. 4 is an illustration of one embodiment of a wiring harness of this disclosure.

FIG. 5 is an illustration of another embodiment of a wiring harness of this disclosure.

FIG. 6 is an illustration of an extension cord for the wiring harnesses of FIGS. 4 and 5.

FIG. 7 is an image of a point-of-view camera mounted to a helmet.

FIG. 8 is a block diagram illustrating a communication device.

FIG. 9 is an illustration of a universal mount.

FIG. 10 is an illustration of a goggle mount.

FIG. 11 is an illustration of a double hook and loop mount.

FIG. 12 is an illustration of a right angle hook and loop mount.

FIG. 13 is an illustration of an adhesive mount.

FIGS. 14 and 15 are illustrations of a helmet having the adhesive mount of FIG. 13 mounted thereon.

FIG. 16 is an illustration of a dual suction cup mount.

FIG. 17 is an illustration of a stationary mount.

FIG. 18 is an illustration of a flex mount.

FIG. 19 is an illustration of a headstrap mount.

FIG. 20 is an illustration of a clamper pod mount.

FIG. 21 is an illustration of a combined mounting device.

FIG. 22 is an illustration of an ultra clamp.

FIG. 23 is an illustration of a super suction mount.

FIG. 24 is an illustration of a mount kit.

FIGS. 25 and 26 are illustrations of various types of eyewear.

FIG. 27 is an illustration of a military and law enforcement mounting device.

FIG. 28-31 are illustrations of personal effects used as mounting devices.

FIG. 32 is a block diagram illustrating a recording device.

FIG. 33 is a block diagram illustrating a power source device.

FIG. 34 is a block diagram illustrating peripheral devices and accessories.

### DETAILED DESCRIPTION

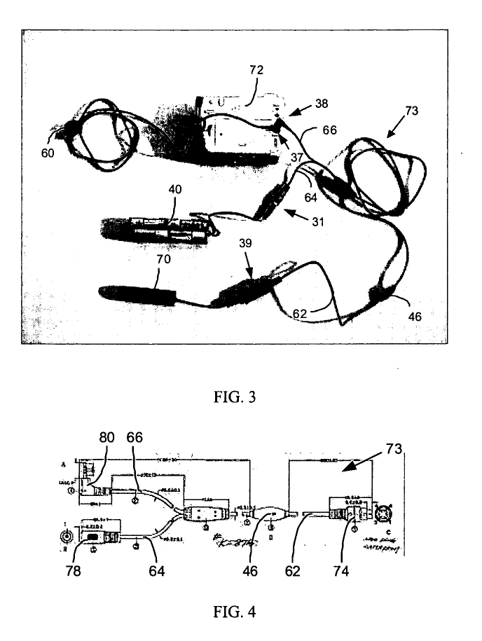

A wiring harness 73 including a camera cord 62, a power cord 64, and an audio-video recording cord 66 is coupled with a power supply 40, a recording device 72 and a point-of-view camera 70 in the embodiment illustrated in FIG. 3. A microphone 46 can be incorporated into the camera cord 62 so as to be able to capture sound and transmit corresponding audio signals from the microphone 46 through conductive wiring in the camera cord 62 to the recording device 72. An embodiment of the wiring harness 73 and related equipment is available from Viosport.com, Inc. of Marquette, Mich., USA, with components manufactured by Sun Disk of Taiwan.

When designed for personal use (i.e., when the camera and other components are affixed to the user), each of the cords 62, 64 and 66 has a length of not more than about 1.5 m. The wiring harness 73 operably joins system components via just three connections, one on each of the three cords 62, 64 and 66. At connection 39, a 4-pin mini-din female connector from the camera is connected with a 4-pin mini-din female connector on a terminal of the camera cord 62. At connection 31, a male 2.1 mm connector from the power supply 40 (in this case, a 12-V power source in the form of a battery pack holding eight AA batteries) is connected with a female 2.1 mm connector on a terminal of the power cord 64. At connection 38, a 3.5 mm male composite plug on a terminal of the recording cord 66 is connected with a 3.5 mm female input on a recording device 72; in this case, the recording cord 66 is connected to an analog input of a hand-held video camera/recorder. The camera cord 62 is connected with both the power cord 64 and the recording cord 66, each at an opposite end from its connector.

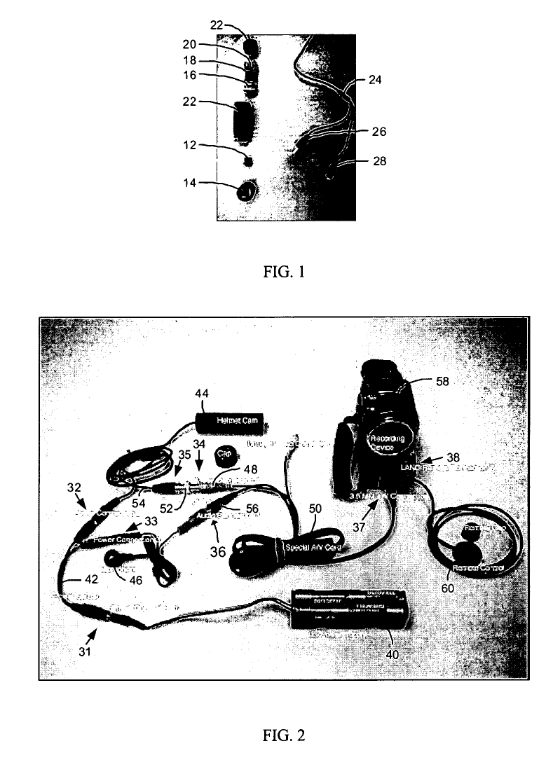

The camera 70 is similar to the camera described in the background, except for the wiring and connectors. The camera 70 captures images and transmits electronic representations to the camera cord 62 of the wiring harness 73 through the camera's connector. In this embodiment, the camera 77 is a tubular-style camera that includes a ¼-inch color charge-coupled device (CCD) sensor from Panasonic. The CCD sensor converts the light pattern that is captured by the camera into electrical signals. The signal processor 18 and printed circuit board 20 (see FIG. 1) convert the signal from the CCD sensor 16 into a signal compatible with the recording device 72 via software written to produce the desired signal format. One embodiment of the camera is sold as the ADVENTURE CAM II by Viosport.com, Inc. (Marquette, Mich., USA), and its technical specifications are as follows:

| | |
|---|---|
| Pick-Up Element: | ¼″ Panasonic Color CCD sensor |
| Number of Pixels: | 512(H) × 492(V)/512(H) × 582(V) |
| Resolution: | 380 TV lines |
| Min. Illumination: | 2 Lux/F2.0 |
| S/N Ratio: | More than 48 dB (AGC off) |
| Electronic Shutter: | 1/60 ( 1/50) to 1/100,000 sec |
| White Balance: | Auto white balance |
| Auto Light Control: | 3 windows detec |
| Load impedance: | 75 ohms |
| Standard Board Lens: | f3.6 mm/F2.0 |
| Lens Angle: | 70 degrees |
| Power Source: | DC12 V +/− 10% |
| Dimension (mm): | 26 (diameter) × 87 (length) |
| Current Consumption: | 80 mA |
| Weight: | 305 g |
| Cord Length: | 2 inches (5 cm) |
| Cord Terminal: | water-tight mini-din 4-pin connection |

The short cord length allows the user to disconnect the camera and wiring harness while keeping the camera attached to the helmet or other mounting area and also allows for multiple options in wiring configurations based on the terminals of the recording device. Further still, the short length of the cord from the camera easily enables coupling to cable extensions for longer runs.

Examples of wiring harnesses 73 and 73′ including the camera cord 62, the power cord 64 and the recording cord 66 are illustrated in FIGS. 4 and 5. In each embodiment, a microphone 46 is incorporated into the camera cord 62 so as to be able to transmit audio signals generated in the microphone 46 through the camera cord 62. One embodiment of the microphone (manufactured by Sun Disk of Taiwan) has the following technical specifications:

| | | |
|---|---|---|
| Audio Output: | 12 | V p—p |
| Power Supply: | 12 | V DC |
| Power Consumption: | 4 | mA |
| Sensitivity: | 58 | dB |
| Resistance: | 2.2 | kΩ |
| Weight: | 5 | g |
| Width: | 6.3 | mm |
| Height: | 29.1 | mm |

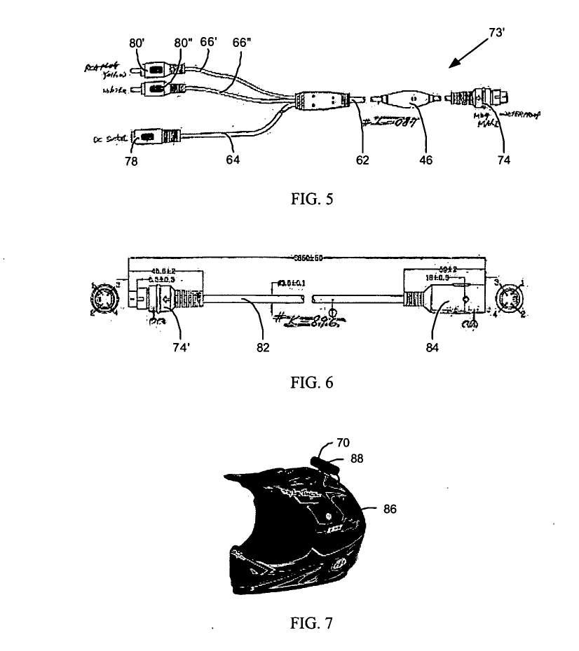

As shown, the power cord 64 connects with the power supply 40 via the power connector 78, which is a female 2.1 mm connector. The recording cord 66 is coupled with the recording device 72 via the recording connector 80, which in FIG. 4 is a 3.5 mm male composite plug (similar to a classic headphone jack). The wiring harness 73′ of FIG. 5 is otherwise similar to that of FIG. 4, except the wiring harness 73′ of FIG. 5 includes a pair of recording cables 66′ and 66″, one cable 66′ having a male RCA video connector 80′, the other cable 66″ having a male RCA audio connector 80″. When the camera is to be placed at a more-remote location (e.g., mounted to the top tube, fork, or chain stay of a user's bicycle or to the hull of a user's kayak), an extension cord 82, illustrated in FIG. 6, can be connected with the camera cord 62. The extension cord 82 includes a female 4-pin mini-din connector 84 at one end for connecting with the connector 74 on the camera cord 62 and a male 4-pin mini-din connector 74′ at its opposite end for connecting with the female mini-din connector on the camera 70.

The types of connectors utilized in these embodiments, however, are provided only by way of example as other types of connectors can be substituted to accommodate changes in the reciprocal connectors on the camera, recording device and/or power supply.

The camera 70 can be attached to a user's helmet 86 via a camera mount 88 secured to the helmet 86, as shown in FIG. 7. When mounted to the user's helmet 86, the camera 70 offers a point-of-view reference that closely matches that of the user (i.e., the camera captures almost exactly what the user sees). Alternatively, the camera 70 can be attached to any other piece of equipment or article of clothing worn or operated by the user. Moreover, the camera can also simply be attached to the user's body, via a headband, for example.

The recording device 72 can be a portable video camera/recorder (camcorder), which is capable of recording live motion video and audio for later replay through videocassette recorders (VCR's), televisions or computers. Alternatively, the recording device 72 can be another type of compact, portable electronic device with a digital or analog storage medium, such as an MP3 player, a personal video player, or a portable hard drive. The power supply 40 can utilize standard batteries (e.g., AA batteries) in a holder with electrical contacts for the batteries, or the power supply can be a rechargeable battery with a male 2.1 mm output connector. A suitable 12-volt rechargeable Li-Ion battery pack is available from Viosport.com, Inc.

With the camera 70 attached, e.g., to the user's helmet, the power supply 40 and recording device 72 can be placed in the user's pockets or in a pack (e.g., a backpack or hydration pack) worn by the user. A remote control 60 includes at least one button or other input means for controlling the recording device (e.g., sending signals to record or stop). The remote control 60 plugs into a designated input on the recording 72 and the controller unit can be held in the user's hand or secured to the user's apparel or equipment for easy manual access by the user. A one-button remote control that works with any LANC-equipped camcorder is available from Viosport, Inc. LANC is a Sony remote control protocol found on select Canon, Sony and other camcorder models. The remote control includes a color LED indicator light; and its functions include power on/off, record, stop, and pause.

The user presses a button on the remote control 60 to commence recording of video and audio from the camera and microphone. Alternatively, the remote control 60 can be omitted from the apparatus, and the user can activate a “record” button on the recording device 72 (e.g., a camcorder set to “VCR” mode) to commence recording. The recording device 72 can then accept signals from the camera 70 and microphone 46. The camera 70 and microphone 46 draw power from the power source 40 to enable them to capture and transmit video and audio, respectively.

The camera 70, wiring harness 73, and other components can be utilized by a user in a wide variety of athletic activities to record, for example, a particular adventure, performance, demonstration or competition. Other applications include use, for example, by military personnel engaged in reconnaissance or combat; for environmental purposes (e.g., observation or tracking of species) by a researcher; in vehicles or aircraft, where the camera is secured to the vehicle or aircraft; in forestry applications, where a forest ranger, for example, can readily record observations of the forest flora and fauna; for training purposes, where recordings can be made of instructional demonstrations or trainee performance; in covert or investigative operations, where the camera and microphone can be used to gather information; in security operations, where the camera and microphone can be used to monitor the premises; in search and rescue operations, where video and audio can be captured for evaluation and future training; in fire fighting, where recorded video and audio can be reviewed, e.g., for performance evaluation and as an evidentiary record for investigating the nature and cause of fires; and by police to capture video and audio that can be used as evidence.

Further, the terms “cord” and “cable” as used herein may be used interchangeably. Both terms may include, but not are not limited to, devices capable of receiving and/or transmitting one or more signals and/or one or more types of signals. The signals may include, but are not limited to, for example, communication signals, data, power signals, electrical signals, electronic data signals, audio signals, and optical signals. The term “modulated data signal” means a communication signal that has one or more of its characteristics set or changed in such a manner as to encode, associate, or embed information in or with the signal.

Further, such signals, or communications signals, may be sent, received, transferred or otherwise communicated via a variety of media. The media, such as a communication link, may include, for example, a carrier wave or other transport mechanism and may include any information delivery media. By way of example, and not limitation, communication media include wired media such as a wired network, a cable, or direct wired connection, and wireless media such as acoustic, RF infrared, infrared, and other wireless media. Combinations of any of the above should also be included with the scope of a communication link.

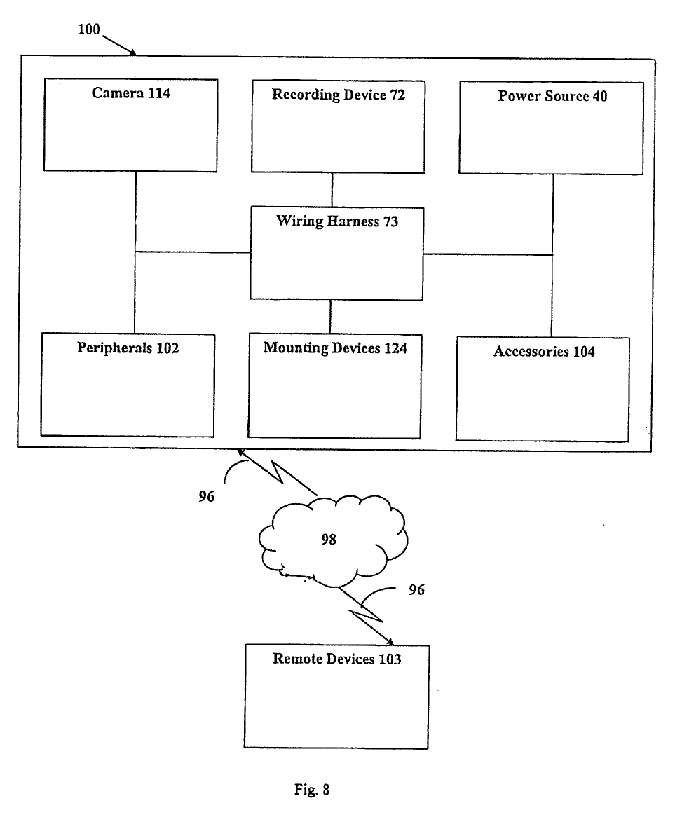

With reference to FIG. 8, and with continuing reference to FIGS. 3-7, there is shown generally a block diagram of communication system 100. The communication system may include, but is not limited to, one or more of the following components in various combinations: the wiring harness 73; a camera 114; the recording device 72; the power source 40; peripherals 102; mounting devices 124; accessories 104. Further, the communication device 100 may include and/or may be associated with one or more remote devices 103 and one or more communication links 174, which may, for example, be integral to or in communication with, the Internet 98.

Wiring Harness

As heretofore described, the wiring harness 73 may include, for example, at least one cable such as the camera cord 62 or the audio/video cable 50. The cable or cables may include one or more connectors 108 for interconnectivity with a preselected device; e.g., the camera 114; the recording device 72; or the power source 40. The connectors 108 may be integrally or independently associated with the cables of the wiring harness 73. For example, the connector 108 may be removably connected with the cable to permit interchangeable connections with various devices by coupling and decoupling the device from the connector 73. In this manner, the technology may promote, for example, use of the wiring harness 73 with a variety of devices. Further, the technology may facilitate fast configuration and reconfiguration of the communication system 100, as may be needed, for example, during a mobile military operation having various communication objectives and changing environmental dynamics.

In various aspects of the technology, one or more cables may be independently or integrally associated with, for example, one or more preselected devices such as, for example, the microphone 46, an earpiece 110, and/or a wireless transceiver 112, as depicted in FIG. 34.

The microphone 46 may configured in various ways with respect to the communication device 100, and may include or be associated with a variety of components. For example, the microphone may be integrally incorporated with the camera cable 62 as a “throat microphone” or miniature microphone. Throat microphone technology may minimize or block out a majority of background noise. In one aspect, the use of a piezoelectric microphone which rests on an individual's neck picks up vibration signals from the user's vocal cords rather than the air vibration signals, which typically include distracting background sounds. The microphone 46 may include, for example, one or more transponders (not shown) for exceptional clarity in communication transmissions. The transponders may be available in a variety of frequencies or form factors. In this manner the quality of the audio information may be improved or maximized, a significant consideration in extremely loud environments such as, for example, when heavy artillery or explosive warfare events or exercises are in progress. Further, due to the microphone's ability to receive vibrations, the user does not have to shout or otherwise raise one's voice for effective communications, thus permitting one to communicate with the utmost discretion where the mission so requires. Microphone windscreens 113 or other devices and components may be used to filter out unwanted noise such as wind noise.

The earpiece 110 may be provided in a variety of configurations and styles. For example, the earpiece may be constructed to fit over the ear, may be integrated into eyewear or headgear, such as affixed to or integrated with the stem or temple of a pair of eyeglasses, or otherwise embodied. The earpiece 110 may be in wired or wireless communication with one or more components of the communication device 100 or other devices, such as mobile telephones or personal digital assistants (PDAs). For example, the earpiece 110 may be in communication with the wiring harness 73 via a coiled cable 126, which may prevent tangled or knotted cables while traversing rigorous environments.

In another example, the earpiece 110 may be designed to fit partially or completely within the user's ear and may include, for example, integrated circuitry (not shown), including, for example, a wireless transceiver 112, to wirelessly receive and amplify, for example, an audio signal to the user. A repeater (not shown) or other components may, for example, remotely interact with the earpiece 110 via, for example, a wireless communication channel. In this manner, the concealed components may facilitate or enhance applications that require covert communications such as law enforcement activities, investigative operations, and so forth.

In another example, the wiring harness 73 may include, for example, a wireless transceiver 112, which may be integrally configured, for example, with the wiring harness 73, or otherwise associated with the communication device 100. The wireless transceiver 112 may, for example, receive, amplify, transmit, or retransmit a signal such as an audio signal, a video signal, or both. The wireless transceiver 112 may provide such functionality with respect to other components of the communication device 100 as well as components and devices not so related, such as remotely-located devices via, for example, a communication link 96.

For example, the wireless transceiver 112 may operate to receive a modulated data signal, such as an audio signal from a remotely-located mobile telephone 103, and retransmit the signal to the earpiece 110. Upon receipt of the audio signal, the wireless transceiver 112 transmits to the earpiece 110, which may be received, for example, by another wireless transceiver 112 integrated with the earpiece 110 or via a cable of the wiring harness 73 connected to the earpiece. In this manner, data and information in various forms may be transferred from one location to another.

Camera

Various aspects of the technology may include various types of cameras 114 having various features. For example, the camera 114 may include, but is not limited to, a still camera 71 or a POV (point-of-view) camera 70 having, for example, a first device 116 (as depicted in FIG. 34) such as a CCD sensor 16 for receipt of waves and translation of waves into visual data or images. This may be accomplished, by example, as described above, whereby the POV camera 70 receives in light waves and the CCD sensor 16 converts the light pattern into electrical signals. The signal processor 18 and printed circuit board 20 (see FIG. 1) convert the signal from the CCD sensor 16 into a signal compatible with the recording device 72 via software written to produce the desired signal format.

The technology may further provide, for example, a capability to capture or receive electromagnetic waves of various lengths, such as those found in both the visible spectrum and the invisible spectrum. These waves may include, for example, ultraviolet waves and infrared waves. For example, infrared energy may be accepted by a CCD sensor 16 or other device, and converted to an electronic signal. Integrated circuitry such as a signal processor 18 or other means may be used to measure the electrical signal and to assign a value corresponding to the measurement, the value representative of a varying degree of brightness, intensity, color, etc.

The values may be then be reconstructed by, for example, various algorithms or processes, to form an image or picture. In this manner, the camera 114 may, for example, be used to capture images in darkness or near darkness, to capture images via the generation of thermal waves (or lack thereof), and to capture images via means other than the traditional ingress of waves from the visible spectrum into the camera 114. As a skilled artisan will note, these aspects may provide or facilitate the many applications and objectives, including, for example, military stealth operations or covert operations that require information gathering in darkness or other conditions that may hamper traditional methods of gathering information.

The camera 114 may be configured and reconfigured with various filters 120 and various lenses 122. For example, the filters 120 may include density neutral filters having various levels of shading. The lenses 122 may include zoom lenses; wide-angle lenses; telephoto lenses; panning devices, which may be used, for example, to pan through a crowd; and so forth.

Further, the camera 114 or other components of the communication device 100 may include predetermined features and qualities. For example, the camera 114 may be designed to conceal or reduce visibility of the components, such as exhibiting a low-profile finish such as non-reflective, anodized coating or a camouflaged pattern. Additionally, the components may include decals or other indicia which may be used, for example, to coordinate complementary parts for purposes of configuration and reconfiguration or for other applications.

The camera 114 or other components may also be water resistant or waterproof, such permitting use in adverse weather conditions, for underwater operations, or other such activities. Miscellaneous components such as replacement lens glass and lens caps (described hereinafter) may also be provided.

The technology may also provide, for example, various mounting devices 124 for the camera 114 or other peripheral devices. The mounting devices 124 may be removably attached to, permanently attached to, partially integrated with, or fully integrated with, for example, headgear 128; eyewear 130; and other objects. The mounting devices may also include, for example, standard issue or specially designed military and law enforcement mounting devices 132; and/or personals effects 134, as hereinafter illustrated and described.

Mounting Devices

With reference now to FIGS. 9-32 and with continuing reference to FIGS. 1-8, there are shown specific mounting devices 124 which may include, but are not limited to, a universal mount 138; a goggle mount 140; a double hook and loop mount 142; a right angle hook and loop mount 144; an adhesive mount 146; a dual suction cup mount 148; a stationary mount 150; a headstrap mount 152; a flex mount 154; clamper pod mount 156; an ultra clamp 158; and a super suction mount 160.

As generally shown in FIG. 9, the universal mount 138 may include, for example, a base 164 and an open sleeve 166. The open sleeve 166 may flexibly receive and hold the camera 114, for example, while a hook and loop backing (not shown) or other component may secure the universal mount 138 to an object such as a helmet 86. The universal mount 138 may comprise various materials or combinations of materials including, for example, rubber.

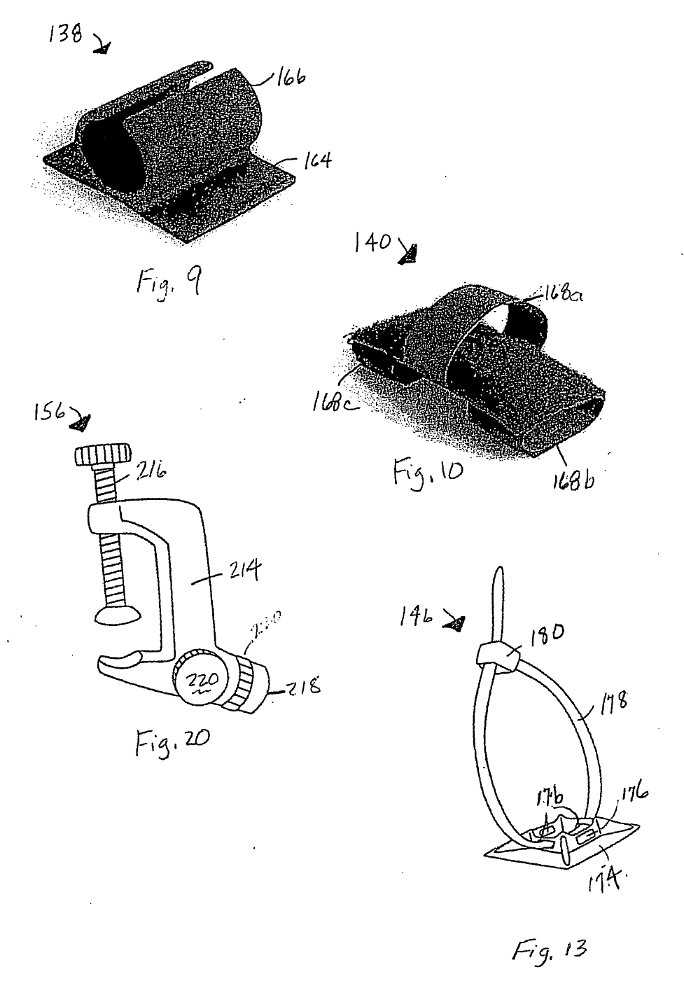

As generally shown in FIG. 10, the goggle mount 140 may comprise, for example, one or more fasteners 168 such as fasteners 168a-168c. The fastener 168a may secure, for example, the camera 114 or other device, while the fasteners 168b and 168c may be used, for example, to secure the goggle mount 140 to a pair of goggles or to other objects. The goggle mount 140 may comprise, for example, a hook and loop fabric or other material and may facilitate efficient fastening and removal to and from various objects. Further, the goggle mount 140 may be used in conjunction with other mounting devices 124 such as the universal mount 138.

As generally shown in FIG. 11, the double hook and loop mount 142 may comprise, for example, a support member 170; a buckle 182; and one or more fasteners 168. The support member 170 may form, for example, one or more grooved portions 170a and 170b for receiving an object such as a camera 114 or for attachment to an object such as the handle bar of a bicycle. In various aspects of the technology, the grooved portions 170a and 170b may be configured as mirror images to one another, thereby providing, for example, support for objects aligned in a parallel manner.

The support member 170 and the buckle 172 may include various materials such as a durable plastic and the fasteners 168 may comprise, for example, a hook and loop fabric. The buckle 172 and the fasteners 168 may provide for or facilitate adjustable fastening of objects to the double hook and loop mount 142 as well as fastening of the double hook and loop mount 142 to various objects. For example, the double hook and loop mount 142 may be removably fastened to motorcycles or police vehicles.

As generally shown in FIG. 12, the right angle hook and loop mount 144 may comprise, for example, the support member 170 forming one or more grooved portions 170a and 170b; a buckle 172; and one or more fasteners 168. Various aspects of the technology, the grooved portions 170a and 170b may be configured at right angles to one another such that objects disposed therein may be aligned, for example, in a perpendicular manner to one another. The right angle hook and loop mount 144 may include various materials such as durable plastic, hook and loop fabric, or other materials, alone or in combination.

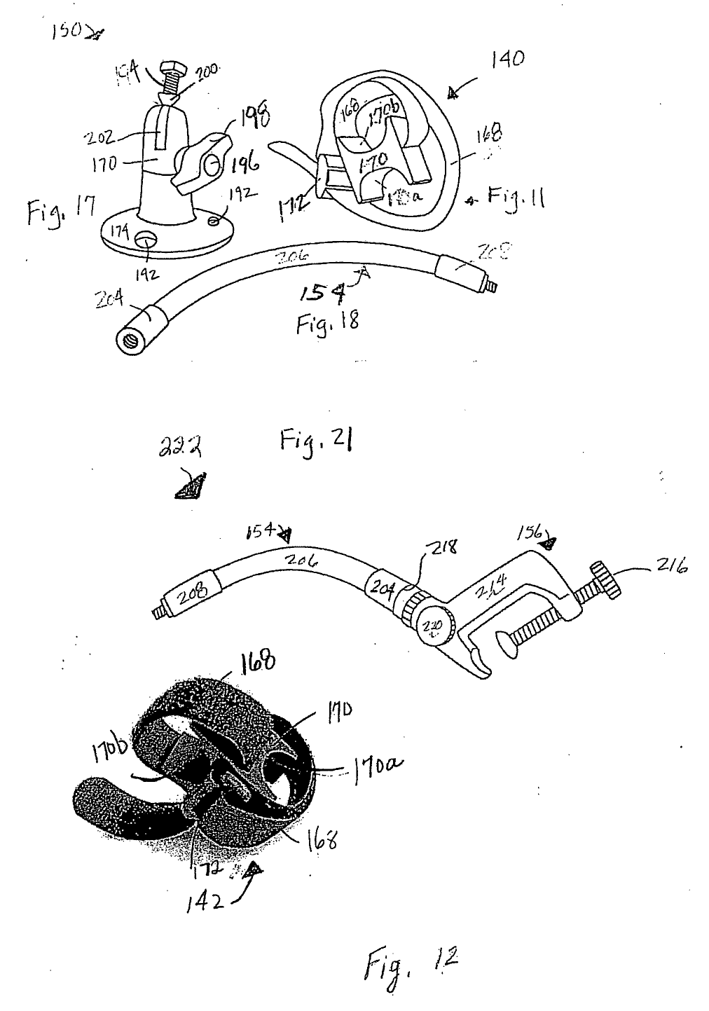

As generally shown in FIG. 13, the adhesive mount 146 may comprise, for example, a base member 174 having one or more slots 176; one or more ties 178 and one or more clasps 180. The base member 174 may be, for example, removably or permanently affixed to an object such as a helmet 86 via, for example, an adhesive or other material or mechanism (not shown) disposed on an underside (not shown) of the base member 174. The ties 178 may be threaded through one or more slots 176 and removably or permanently fastened via, for example, one or more clasps 180.

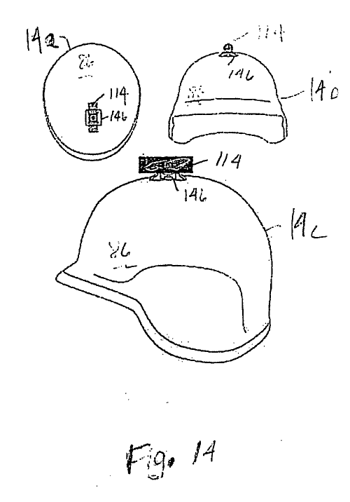

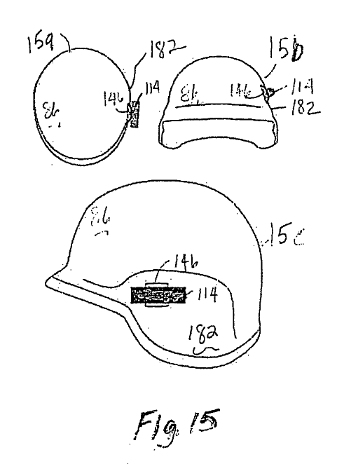

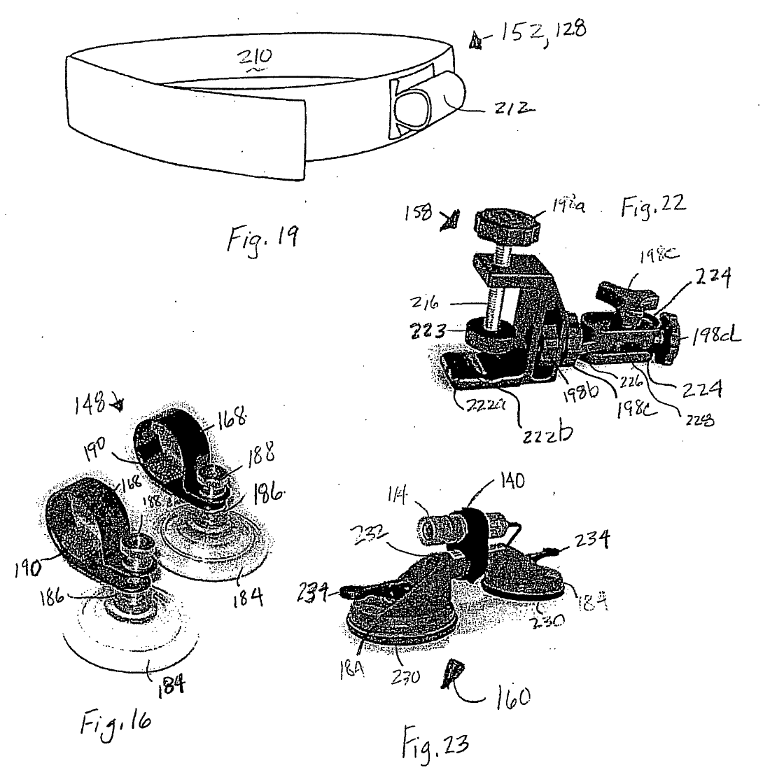

For example, as shown in FIGS. 14 and 15, there are shown two configurations of the helmet 86 having the camera 114 attached thereto via the adhesive mount 146. In FIG. 14, a top view 14a, front view 14b, and side view 14c illustrate an example of the camera 114 mounted atop the helmet 86 via the adhesive mount 146. In FIG. 15, there is shown a top view 15a, front view 15b, and side view 15c, which illustrate the camera 114 mounted on a side 182 of the helmet 86.

As generally shown in FIG. 16, the dual suction cup mount 148 may comprise, for example, one or more suction cups 184. Each suction cup 184 may include, for example, a stem 186 having a fastener 168 removably attached thereto by, for example, a thumbscrew 188. Padding 190 may be included to protect, position, or secure the camera 114 or object fastened in the dual suction cup mount 148. A force exerted on, for example, the thumbscrew 188, may create a vacuum within the suction cup 184, forming a seal. The seal may provide, for example, a powerful hold on a vehicle or other object, and may also serve to stabilize the fastened object.

As generally shown in FIG. 17, the stationary mount 150 may comprise, for example, a base member 174 having mounting holes 192 formed therein; support member 170; a set screw 194; recessed screw 196; and an adjustment knob 198. The base member 174 may serve to anchor the stationary mount 150 to, for example, a car, boat, snowmobile, wall, or other flat surface via, for example, bolts (not shown) in mechanical association with the holes 192 of the base member 174. The set screw 194 may serve as a mount for the camera 114 or other devices, and a ball joint 200 may facilitate, for example, a 360° rotation of the set screw 194 with respect to a vertical axis, thus permitting a mounted camera 114 to swivel to a predetermined position.

In various aspects of the technology, the ball joint 200 and set screw 194 may be translated along a path such as the slot 202 and may be relocatably secured to a point respective to the slot 202. The adjustment knob 198 and recessed screw 196 may facilitate adjustment of various components of the stationary mount. In this manner, a device attached to set screw 194 may be selectively positioned to a desired angle relative to, for example, the support member 170.

As generally shown in FIG. 18, the flex mount 154 may comprise, for example, an arm 206 having connectors such as a female member 204 and a male member 208 at either end. The arm 206 may be flexible, rigid, or adaptably rigid; i.e., capable of location or relocation to a desired position by exerting a force on the arm 206, such as bending. Once positioned, the arm 206 is capable of maintaining the static position until repositioned by application of pressure. The female member 204 may, for example, couple and decouple to and from the set screw 194 of the stationary mount 150 while the camera 114 may be mechanically associated with the male member 208. In this manner, the camera 114 may be securely mounted to a boat, wall or other object and still remain repositionable via the flex mount 154.

As generally shown in FIG. 19, the headstrap mount 152 may comprise, for example, a band 210 having a closed sleeve 212 in mechanical association therewith, the closed sleeve 212 for removably securing a device such as the camera 114, for example. The band 210 may be configured, for example, as a unitary device, such as a stretch headband, or may include fastening means, such as complementary hook and loop components (not shown) to fasten the band 210 about the head.

As generally shown in FIG. 20, the clamper pod mount 156 may comprise, for example, a C-clamp 214; a clamp screw 216; and a mounting end 218. The clamp screw 216 may be tightened or loosened to facilitate clamping of an object or device between the clamp screw 216 and the C-clamp 214. The camera 114 or other device may be mounted, for example, to the mounting end 218 via, for example, a threaded connection (not shown) or other means. Adjustment screws 220 may be tightened or loosened to adjust a relative position of the clamper pod mount 56 or its mounting end 218.

As illustrated in FIG. 21, one or more of the aforementioned mounting devices 124 may be combined for various applications. For example, the clamper pod mount 156 may be joined with the flex mount 154 via the mounting end 218 and female end 204, respectively, as shown at 222. In this manner, the C-clamp 214 may be secured to an object such as a table, and the camera 114 may be mounted on the flex mount 154, and then adjusted to a desired position via the arm 206.

As generally shown in FIG. 22, the ultra clamp 158 may comprise, for example, the C-clamp 214; the clamp screw 216; grommet 223; plates 224; shelf 226; and inline screw 228. For example, the ultra clamp 158 may be attached to an object such as a vessel or car by mounting the ultra clamp 158 onto the object and adjusting the clamp screw 216 with the adjustment knob 198a such that the grommet 222 and the C-clamp base 222a grasp the object. The C-clamp base 222a may form, for example, a groove 222b therein, to facilitate, for example, tubular or cylindrical objects such as motorcycle handlebars. The camera 114 or other device may be mounted, for example, on a male member (not shown) associated with an end of the adjustment knob 198d.

The angle and level of the mounted camera 114 or device may be adjusted in several manners. For example, the mounted camera 114 may be translated along a vertical axis by adjustment of opposing knobs 198b and 198c, which may be connected for example, by a connection member (not shown) which traverses a slot (not shown) of the C-clamp 214. The mounted camera may also be positioned relative to a horizontal plane by, for example, by adjusting the inline screw 220 with the adjustment knob 198e to bring the plates 224 in relatively closer spatial proximity to one another. The inline screw 228 may connect, for example, an end (not shown) of the shelf 226 and the plates 224, such that the plates 224 may pivot about the end of the shelf 226 by loosening the inline screw 228, and the plates 224 may be fixed in a static position by tightening the inline screw 228. Finally, the mounted camera 114 or other device may be rotated 360° about a horizontal axis, for example, by adjusting the knob 198c to allow rotation of the connecting member (not shown).

As generally shown in FIG. 23, the super suction mount 160 may comprise, for example, one or more suction cups 184, each suction cup 184 having an associated diaphragm 230 and an associated lever 234. The suctions cups 184 may be connected to one another by a bridge 232. The camera 114 or other device may be mounted, for example, to the bridge 232 via the double hook and loop mount 142, as illustrated. The super suction mount 160 may be securely attached to a surface such as a boat, wall, or vehicle by, for example, exerting pressure on the levers 234. Each lever 234, in turn, may lift a rod (not shown) connected to the respective diaphragm 230, which may create a vacuum between the diaphragm 23 and the surface to which it's mounted. The vacuum, in turn, may create a seal whereby the diaphragm 230 meets the surface, holding the super suction mount 160 tightly thereto. The super suction mount 160 may be released from the surface by simply lifting the levers 234, which may force the respective rods (not shown) to press upon the diaphragms 230, raising the air pressure inside the diaphragms 230, and breaking the seals.

The mounting devices 124 may promote, for example, hands-free operation of the camera 114 or other devices, permitting the user to engage in a variety of activities such as operating a vehicle or other equipment. As one skilled in the art will recognize, all of the foregoing mounting devices 124 may include various components and subcomponents of varying dimensions and various materials, alone or in combination.

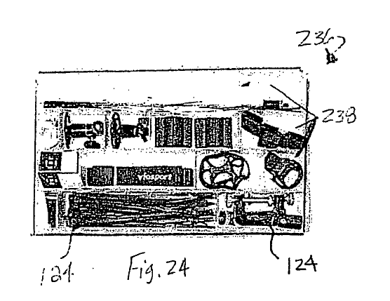

As generally illustrated in FIG. 24, the foregoing or other mounting devices 124, peripherals 102, or other objects and components may be stored or transported, for example, in a mount kit 236. The mount kit 236 may contain, for example, various compartments 238 of various sizes to accommodate the mounting devices 124 and/or miscellany. The mount kit 236 may include one or more materials, such as a clear, rigid plastic to lend durability as well as visibility of the contents of the mount kit 236.

The eyewear 130 may include, for example, eyeglasses, including corrective glasses, recreational glasses, and sunglasses; protective eyewear, including ski goggles; safety goggles; scuba masks and underwater eyewear; and standard issue or specially designed military eyewear. In various aspects of the technology, the camera 114, the wireless transceiver 112, or other peripherals 102 may be integrated into the eyewear or otherwise attached.

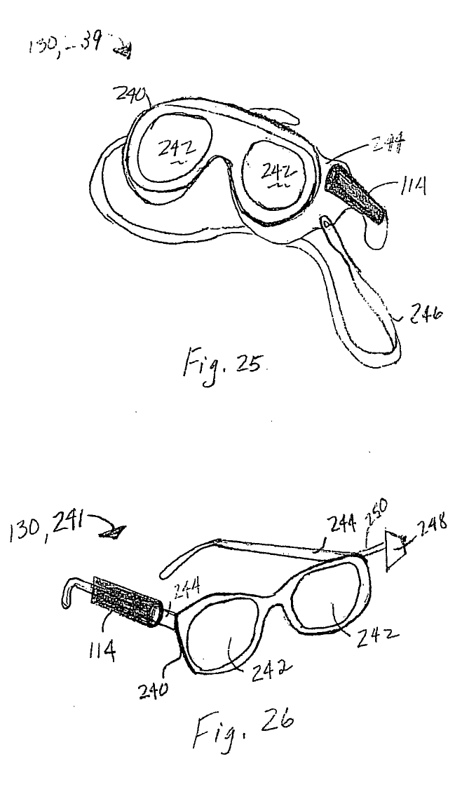

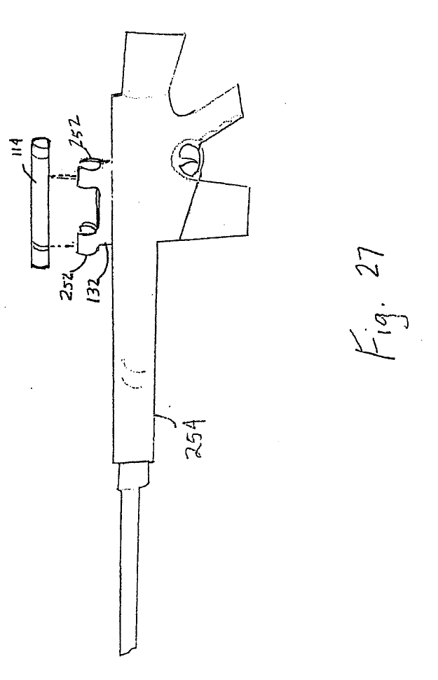

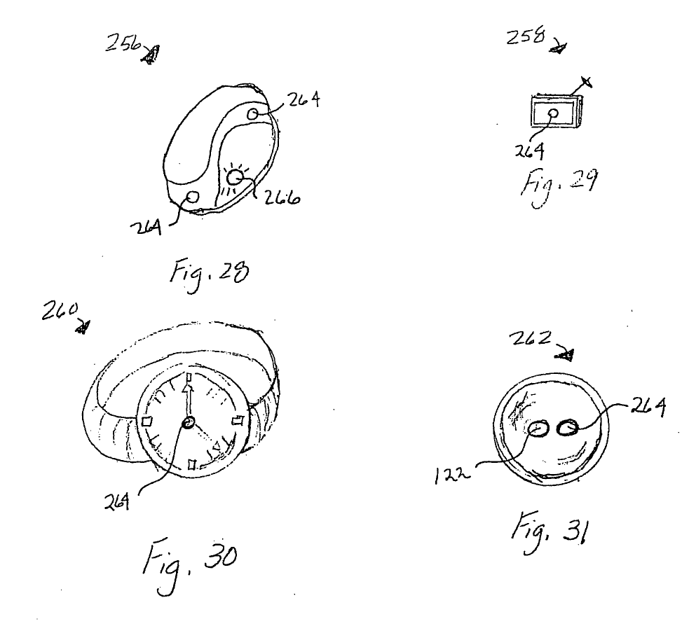

As generally illustrated in FIGS. 25-26, the eyewear 130 may include, for example, protective eyewear 239, such as scuba masks, ski masks, or safety goggles; or eyeglasses 241. The eyewear 130, 239, and 241 may comprise for example, frames 240; lenses 242; temples 244; and/or other components or subcomponents, alone or in combination. For example, the protective eyewear 239 may further comprise a shield or visor (not shown) and a neck strap 246. The lenses 242 may include, for example, clear lenses, photosensitive lenses, corrective lenses, and so forth. Various materials and configurations of the eyewear 130 are possible.

The camera 114 or other device such as a display device 248 may be mounted or otherwise removably or permanently attached to various components of the eyewear 130, such as the temple 244. The mounting means may include, for example, mounting devices 124 as heretofore described or others as are known in the art. The camera 114, for example, may capture various images and transmit, via a wireless receiver 112, for example, the images to local devices associated with the communication device 100, to remote devices 103, or to both.

The display device 248 may be foldably mounted, for example, to the temple 244 of the eyeglasses 241 by mounting means such as a folding arm 250, which may include, for example hinged ends (not shown) or other devices to facilitate positioning and repositioning the display device 248. For example, the hinges (not shown) and the folding arm 250 may operate to extend the display device 248 a distance from the user for viewing and foldably store the display device 248 flush against the side of the user's head, when not in use. The display device 248 may be used in conjunction with other devices, such as the wireless transceiver 112 to receive and display video images from for example, the camera 114 or from a remote device, such as the camera 114 of a military unit capturing images in a different locale.

As generally illustrated in FIG. 27, the military and law enforcement mounting devices 132 may include, for example, standard issue mounting devices such as those commonly configured with military weapons 254. The military and law enforcement mounting device 132, may comprise, for example, one or more clips 252 for removably enclasping or partially enclasping the camera 114 or other device.

The camera 114 may be associated with a display device 248 or other devices. For example, a soldier may be armed with the standard issue military rifle 254 having the camera 114 mounted thereon via the military and law enforcement mounting device 132. The soldier may also don military issued eyewear 130 having, for example, the display device 248. The camera 114 may be in communication with the display device 248 via, for example, the camera cord 62 or one or more wireless transceivers 112. In this manner, for example, a soldier advancing into enemy territory may take cover alongside a building, extend the barrel of the rifle having the mounted camera 114 around the corner of the building while remaining shielded by the building. The camera 114 may capture views of the enemy territory, and transmit an image or video stream via the wireless transceiver 112 or camera cord 62 to the display device 248. Upon receipt and display of the image or video stream by the display device 248, the soldier may view the images from the protective cover of the building and make command decisions based on the ingress of information. A skilled artisan will appreciate that standard issue or specially designed military and law enforcement equipment need not be limited to weapons artillery. Due to the numerosity of such equipment and items, an exhaustive list is not enumerated herein.

As generally illustrated in FIG. 28-31, there are shown various mounting devices 124 in the form of personal effects 134. These mounting devices 124 may include, but are not limited to, a brooch 256, lapel pin 258, watch 260, or button 262. The camera 114, wireless transceiver 112, or other components such as a microchip for information processing may be mounted on or in the personal effects 134.

The camera 114, for example, may be concealed within design and/or functional elements 264, of the brooch 160 to permit, for example, investigative interviews. Alternatively, the personal effects may be configured with, for example, the lens 122 of the camera 114 visible to an observer. In both of the foregoing scenarios, for example, a veridical record of the events, conversations, and parties may be recorded.

Further, a visual indicator 266 such as small signaling light may be incorporated with the personal effects 134, as shown in FIG. 28. When lighted, for example, the visual indicator 266 may provide an indication to those present that they are being recorded. Further, mounting devices 124 such as personal effects 134 that are not mounted to headgear 128 or eyewear 130 may minimize or eliminate blurring of video images or other undesirable effects caused by movements of the head.

Recording Device

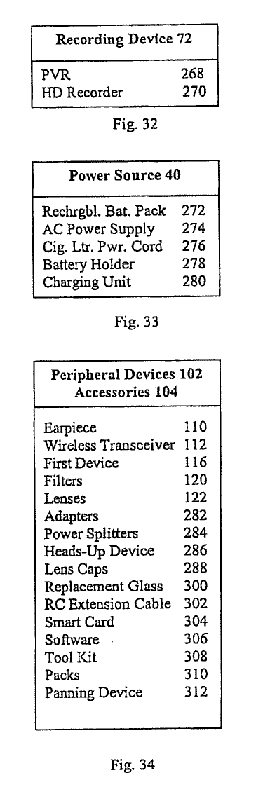

As shown generally in block diagram form in FIG. 32 at 72, and with reference once again to FIG. 8, the recording device 72 may include, incorporate, or communicate with, for example, a personal video recorder (PVR) 268 or a hard drive recorder (HD recorder) 270.

The PVR 268 may provide, for example, an interactive recording device and may record an incoming video data stream, store the video data on a hard drive (not shown) or other storage media, and may provide for replay of the recorded video on a playback device such as the display device 248 by transferring a video signal via a wireless or wired device, such as the wireless transceiver 112 or the camera audio/visual cable 50, respectively. The PVR 268 may further include, for example, various functions such as time and date marking, indexing, non-linear editing or other capabilities.

The HD recorder 270 may, for example, include a high-capacity disk drive (not shown) and may be used, for example, for temporary recordings as well as for more permanent recordings. For example, the technology may provide for DVD (digital versatile disc) recording capabilities and functionality.

Power Source

As shown generally in block diagram form in FIG. 33 at 40, and with continuing reference to FIG. 8, the power source 40 may include, for example, a variety of devices and accessories. For example, the power source 40 may include a rechargeable battery pack 272; an AC 12 volt power supply 274; a 12 volt cigarette lighter power cord 276; a battery holder 278; a charging unit 280; or other components.

Peripheral Devices and Accessories

As shown generally in block diagram form in FIG. 34, the technology may include a variety of peripheral devices 102 and accessories 104. The peripheral devices 102 may include, for example, but are not limited to, the earpiece 110; the wireless transceiver 112; adapters 282; power splitters 284; a heads-up device 286; and so forth. The accessories may include, for example, lens caps 288; replacement glass 300 for lenses and so forth; remote control 60; a remote control extension cable 302.

The heads-up device 296 may include, for example, a microchip (not shown) and a light-emitting diode (LED) (not shown), or other components as are known in the art. The microchip (not shown) and LED (not shown) may be integrated or independently associated with, for example, the wiring harness 73; eyewear 130; various other peripheral devices 102; or other clothing, devices, or objects. The microchip (not shown) may serve as a processing device to provide a signal via a communication link 96 to the LED (not shown). The LED (not shown) may move rapidly back and forth across the field of vision of the user, imposing an image on the retina of the user that appears to float in space, thus visual or other information may be provided to the user. In various aspects of the technology, the image may be imposed or superimposed on, for example, the lens 122 of eyewear 130 worn by the user. In this manner, for example, the user may take advantage of numerous applications of the technology.

In one example, the user may transmit, via the wireless transceiver 112 of the wiring harness 73, a request for assistance in pinpointing the user's exact location as well as information pertinent to the surrounding territory. The request may be transferred by a communication link 96 to a remote device 103 such as a remote computer (not shown). The remote device 103, the microchip (not shown), or both may utilize, for example, GPS (Global Positioning System) technology, to determine the location of the user via triangulation. The location information, together with relative maps or other topographical information, may be transmitted via the communication link 96 to the wireless transceiver 112, which may, in turn, provide the information to the heads-up device 296 for display on the eyewear 130 of the user.

The adapters 282 may provide compatibility functionality between various cables and the recording device 72; the camera 114; or other devices. The power splitters 284 may provide power to from a single power supply, such as the power source 40, to two devices simultaneously, thus permitting operation, for example, of the camera 114 and the recording device 72 at once.

Various aspects of the technology may include, for example, peripheral devices 102 such as a smart card 304 and software 306 for interactive use with various devices, such as the recording device 72. The smart card 304 may comprise, for example, plastic card or other device having an embedded microchip (not shown) for receipt, storage and/or transmission of data. In this manner, for example, mission-critical data may be transferred to and from the smart card 304 as needed, and video editing may be accomplished via, for example, one or more software modules (not shown) of the software 306 adapted for use on one or more devices; i.e., the recording device 72 or the display device 248.

The technology may further provide the tool kit 308 to house and protect various tools and accessories. For example, the tool kit 308 may include Allen wrenches and T-wrenches for configuring and reconfiguring the camera 114 with various lenses 122 and filters 120. In various aspects of the technology, the tool kit 308 may provide storage of the tools at home or the office, or may, for example, be transportable to assist with efficient reconfiguration of the communication device 100 while in the field or on a mission.

The technology may further comprise, for example, packs 310 such as a camcorder waist pack which may be fastened or attached about the user's waist, for example; an adventure pack, such as a backpack, for example; or a container case such as a durable, plastic container for transporting various components, subcomponents, and other objects and devices.

While this invention has been shown and described with references to particular embodiments thereof, those skilled in the art will understand that various changes in form and details may be made therein without departing from the scope of the invention, which is limited only by the following claims.

What is claimed is:

1. A communication system comprising:
a camera for receiving an image and for generating a video signal; and
a wiring harness having:
at least one cable for interconnection with the camera or a preselected device, the at least one cable capable of transmitting the video signal, an audio signal, or power.

2. The communication system of claim 1, wherein the camera further comprises:
a POV camera;
a still camera;
a density neutral filter;
a zoom lens;
a telephoto lens; or
a wide-angle lens.

3. The communication system of claim 1, wherein the camera further comprises a first device for receiving waves from the electromagnetic spectrum.

4. The communication system of claim 3, wherein the waves are invisible waves.

5. The communication system of claim 3, wherein the waves are infrared waves.

6. The communication system of claim 1, further comprising a display device, the display device in communication with the camera, the display device for receiving the video signal and displaying an image.

7. The communication system of claim 1, wherein the at least one cable of the wiring harness further comprises:
a camera cable for interconnection with the camera, the camera cable capable of transmitting the video signal, the audio signal, or the power;
a recording cable for interconnection with a recording device, the recording cable capable transmitting the video signal, the audio signal, or the power; or
a power cable for interconnection with a power supply, the power cable capable of transmitting the power from the supply.

8. The communication system of claim 1, wherein the wiring harness further comprises no more than three connectors for forming at least one interconnection associated with the at least one cable.

9. The communication system of claim 1, wherein the wiring harness further comprises:
an extension cable;
a power splitter; or
an adapter.

10. The communication system of claim 1, wherein the wiring harness further comprises a microphone in communication with the at least one cable, the microphone for capturing the audio signal.

11. The communication system of claim 1, wherein the at least one cable further comprises an audio-visual cable for transferring an audio signal and a visual signal to the preselected device.

12. The communication system of claim 1, wherein the preselected device further comprises:
the recording device;
the power source;
a mounting device;
eyewear;
headgear;
an earpiece;
a remote control;
a heads-up device;
a display device;
a wired transmission device; or
a wireless transmission device.

13. A communication system comprising:
a camera for receiving an image and for providing a video signal;
a mounting device mechanically associated with the camera; and
a wiring harness having:
at least one cable for interconnection with the camera or a preselected device, the at least one cable capable of transmitting the video signal, an audio signal, or power.

14. The communication system of claim 13 wherein the mounting device further comprises:
a military and law enforcement mounting device;
a universal mount;
a goggle mount;
a double hook and loop mount;
a right angle hook and loop mount;
an adhesive mount;
a dual suction cup;
a stationary mount;
a headstrap mount;
a flex mount;
a clamper pod mount;
an ultra clamp;
a super suction mount;
a personal effect;
a brooch;
a button;
a lapel pin;
clothing; or
a strap.

15. The communication system of claim 13 further comprising eyewear.

16. The communication system of claim 15, wherein the eyewear further comprises:
glasses;
sunglasses;
military eyewear;
recreational eyewear;
goggles;
protective eyewear;
safety eyewear;
scuba eyewear; or
underwater eyewear.

17. The communication system of claim 15, wherein the eyewear further comprises:
a wireless transmission device; or
a wired transmission device.

18. The communication system of claim 13, further comprising a heads-up device.

19. The communication system of claim 13, further comprising:
a panning device associated with the camera;
a smart card associated with the camera; the wiring harness; or the preselected device;
a display device for displaying an image; or
at least one software module associated with the camera; the wiring harness; or the preselected device.

20. The communication system of claim 13, further comprising at least one accessory.

21. A communication system comprising:
a camera for receiving an image and generating a video signal;
a mounting device mechanically associated with the camera;
a wiring harness in communication with the camera, the wiring harness having:
at least one cable for receiving and for transferring:
a video signal;
an audio signal;
an audio-video signal; and
a power signal;
a recording device in communication with the wiring harness, the recording device for receiving and recording the video signal, the audio signal, or the audio-video signal; and
a power source in communication with the wiring harness, the power source for generating power.

22. The communication system of claim 21, wherein the power source further comprises:
a battery;
a rechargeable battery pack;
a power supply;
a charging unit; or
a cigarette lighter power cord.

23. The communication system of claim 21, further comprising a tool kit or a mount kit.

24. The communication system of claim 21, further comprising a display device or a heads-up device for displaying an image associated with the video signal.

25. The communication system of claim 21, wherein the camera further comprises:
a point-of-view camera; or
a still camera.

26. A wiring harness for interconnection with at least one preselected device, the wiring harness comprising:
a camera cable for transferring a video signal, an audio signal, or an audio-video signal;
a recording cable in communication with the camera cable, the recording cable for transferring the video signal, the audio signal, or the audio-video signal; and
a power cable in communication with the camera cable or the recording cable, the power cable for transferring power.

27. The wiring harness of claim 26, further comprising three or fewer connectors mechanically associated with the camera cable, the recording cable, or the power cable, the three or fewer connectors for interconnectivity between at least one cable and the at least one preselected device.

28. The wiring harness of claim 26, further comprising the at least one preselected device.

29. The wiring harness of claim 26, wherein the at least one preselected device further comprises a predetermined profile.

30. The wiring harness of claim 26 wherein the at least one preselected device further comprises:
a camera associated with the camera cable;
a recording device associated with the recording cable; and
a power source associated with the power cable.

31. The wiring harness of claim 26 further comprising:
a communication signal for providing information;
a wiring harness for transferring the communication signal; and
at least one device for sending the communication signal to the wiring harness or for receiving the communication signal from the wiring harness.

32. The wiring harness of claim 31, wherein the communication signal further comprises:
a video signal;
an audio signal;
a power signal; or
a modulated data signal.

33. The wiring harness of claim 31, wherein the wiring harness further comprises at least one communication link for transferring the communication signal.

34. The wiring harness of claim 31, wherein the at least one device further comprises:
a camera;
a recording device;
a power source;
a mounting device;
a peripheral device; or
an accessory.
